(19) United States
(12) Patent Application Publication
(10) Pub. No.: US 2012/0062135 A1
(43) Pub. Date: Mar. 15, 2012

(54) DISPLAY APPARATUS AND METHOD OF DRIVING PIXEL THEREOF

(75) Inventors: Junya Tamaki, Chiba-shi (JP); Nobuhiko Sato, Mobara-shi (JP)

(73) Assignee: CANON KABUSHIKI KAISHA, Tokyo (JP)

(21) Appl. No.: 13/228,148

(22) Filed: Sep. 8, 2011

(30) Foreign Application Priority Data
Sep. 13, 2010 (JP) 2010-204023

(51) Int. Cl. H05B 37/02

(52) U.S. Cl. 315/210

(57) ABSTRACT

A display apparatus includes a plurality of pixels each including first and second organic EL elements whose emitting periods are controlled by respective emitting-period control TFTs. The second organic EL element has a front luminance lower than that of the first organic EL element. An electric charge charged in a storage capacitor as a gradation display signal in a previous frame is erased through an erasing TFT and the second organic EL element.

### BACKGROUND OF THE INVENTION

1. Field of the Invention

The present invention relates to a display apparatus that uses an organic electroluminescent (EL) element and, in particular, to an organic EL display apparatus that uses an organic EL element and that can increase efficiency of utilization of light in the frontal direction and to a method of driving the same.

2. Description of the Related Art

An organic EL display apparatus is configured such that a plurality of pixels including organic EL elements are arranged in a matrix on a substrate. The organic EL element in each of the pixels is connected in series to a driving thin-film transistor (TFT) for driving the organic EL element and a power line for supplying power to the organic EL element. A current supplied from the power line causes the organic EL element to emit light, and the light is output to the outside of the organic EL display apparatus.

A known issue for an organic EL display apparatus is low light extraction efficiency. This is because an organic EL element outputs light with various angles from its light-emitting layer and thus a large amount of a total reflection component occurs at a boundary surface between a protective layer and an external space, and most of the emitted light is confined within the apparatus. To address this issue, various configurations have been proposed. For example, Japanese Patent Laid-Open No. 2004-039500 discloses a configuration in which a lens array made of resin is disposed on a silicon oxynitride (SiNₓO_{y}) film that seals an organic EL element to increase the extraction efficiency of light to the front.

Japanese Patent Laid-Open No. 2003-122301 discloses a configuration in which an emitting-period control TFT is positioned in series between a power line and an organic EL element to achieve good movie display characteristics.

### SUMMARY OF THE INVENTION

For the configuration disclosed in Japanese Patent Laid-Open No. 2004-039500, in which the lens array is disposed, the front luminance of the display apparatus can be improved by the effect of concentrating light.

Unfortunately, however, because the luminance in an oblique direction of the display apparatus is decreased, a large view angle is not obtainable. The above-described issue, which has been described for an organic EL element using a lens array, also applies to an organic EL element having the interference effect. For such an element, the luminance in a direction in which the effect of strengthening interference is effective is increased, whereas the luminance in a direction in which the interference effect is weak is decreased. With such a configuration, a large view angle is also not obtainable.

Depending on a user scene, a large view angle may be required. However, it is difficult to use a configuration in which a lens array is disposed on an organic EL element in such a user scene.

When the driving of controlling an emitting period disclosed in Japanese Patent Laid-Open No. 2003-122301 is performed on an organic EL display apparatus that includes a lens array, the issue described below arises.

When the driving disclosed in Japanese Patent Laid-Open No. 2003-122301 is performed, in resetting a gradation display signal in a previous frame in a drive sequence, an organic EL element is energized and emits light. The emitted light is superimposed on emitted light for achieving gradation display (hereinafter referred to as “superimposed light”). For the configuration in which a lens array is disposed on an organic EL element and the front luminance is increased, when the driving disclosed in Japanese Patent Laid-Open No. 2003-122301 is performed thereon, because both the luminance of emitted light for achieving gradation display and that of superimposed light are increased, there is an issue in that the front luminance is increased, but the contrast is not increased.

The present invention provides an organic EL display apparatus that uses an organic EL element and that allows selecting “displaying with enhanced efficiency of utilization of light and an increased front luminance (emission efficiency)” or “displaying with a large view angle” in response to a user scene.

The present invention provides an organic EL display apparatus that has an increased contrast, the organic EL display apparatus including an organic EL element with an increased front luminance and an emitting-period control TFT disposed in series between a power line and the organic EL element and performing driving of controlling an emitting period.

According to a first aspect of the present invention, a method of driving a pixel of a display apparatus including a plurality of pixels is provided. Each of the plurality of pixels includes: a plurality of sub-pixels of the same hue each composed of a respective organic electroluminescent element, an emitting-period control transistor that controls an emitting period of each of the organic electroluminescent elements, a driving transistor that supplies a current to the organic electroluminescent element through the emitting-period control transistor, a storage capacitor that is connected to a gate terminal of the driving transistor and that stores display information, and an erasing transistor that is connected between the storage capacitor and a route from the driving transistor to the emitting-period control transistor. The plurality of sub-pixels includes a first sub-pixel and a second sub-pixel having a front luminance lower than that of the first sub-pixel. The method includes erasing display information stored in the storage capacitor as a gradation display signal in a previous frame in the pixel through the organic electroluminescent element of the second sub-pixel of the plurality of sub-pixels included in the pixel.

According to a second aspect of the present invention, a display apparatus includes a plurality of pixels. Each of the plurality of pixels includes: a plurality of sub-pixels of the same hue each composed of a respective organic electroluminescent element, an emitting-period control transistor that controls an emitting period of each of the organic electroluminescent elements, a driving transistor that supplies a current to the organic electroluminescent element through the emitting-period control transistor, a storage capacitor that is connected to a gate terminal of the driving transistor and that stores display information, and an erasing transistor that is connected between the storage capacitor and a route from the driving transistor to the emitting-period control transistor. The plurality of sub-pixels includes a first sub-pixel and a second sub-pixel having a front luminance lower than that of the first sub-pixel. Display information stored in the storage capacitor as a gradation display signal in a previous frame in the pixel is erased through the organic electroluminescent element of the second sub-pixel of the plurality of sub-pixels included in the pixel.

The organic EL display apparatus includes the plurality of pixels each including a plurality of sub-pixels having different optical properties. The plurality of sub-pixels includes a sub-pixel having an increased front luminance. The emitting periods of the sub-pixels are independently controlled. With this, the organic EL display apparatus allows selecting “displaying with enhanced efficiency of utilization of light and an increased front luminance (emission efficiency)” or “displaying with a large view angle” in response to a user scene.

With driving using only a sub-pixel with an increased front luminance, a luminance substantially equivalent to that of a sub-pixel having a luminance that is not increased is obtainable at a low current. Accordingly, low power consumption can be achieved.

Driving the plurality of sub-pixels having different optical properties at the same time or on a time-series basis enables enhancing efficiency of utilization of light while maintaining satisfactory view-angle characteristics.

For the embodiments of the present invention, each pixel includes a plurality of sub-pixels having different optical properties and including a sub-pixel with an increased front luminance, the emitting periods of the sub-pixels are independently controlled, and gradation display data in a previous frame is erased through an organic EL element that corresponds to a sub-pixel with a low front luminance. With this, the luminance in a dark time can be reduced, and the contrast can be increased.

Further features of the present invention will become apparent from the following description of exemplary embodiments with reference to the attached drawings.

### BRIEF DESCRIPTION OF THE DRAWINGS

FIG. 1 is a schematic plan view that illustrates a configuration of an organic EL display apparatus according to an embodiment of the present invention.

FIG. 2 is a schematic plan view that illustrates a pixel array of the organic EL display apparatus according to the embodiment of the present invention.

FIGS. 3A to 3C are schematic cross-sectional views that illustrate pixel arrangements of the organic EL display apparatus according to the embodiment of the present invention.

FIGS. 4A and 4B illustrate dependences of a luminance on an angle of the organic EL display apparatus according to the embodiment of the present invention.

FIG. 5 illustrates a pixel circuit of the organic EL display apparatus according to the embodiment of the present invention.

FIG. 6 is a timing chart that illustrates an example drive sequence for a driving method according to the embodiment of the present invention.

FIG. 7 is a timing chart that illustrates another example drive sequence for the driving method according to the embodiment of the present invention.

FIG. 8 is a timing chart that illustrates still another example drive sequence for the driving method according to the embodiment of the present invention.

FIG. 9 is a timing chart that illustrates a drive sequence for a driving method according to a comparative example.

FIG. 10 is a timing chart that illustrates a drive sequence for a driving method according to another comparative example.

### DESCRIPTION OF THE EMBODIMENTS

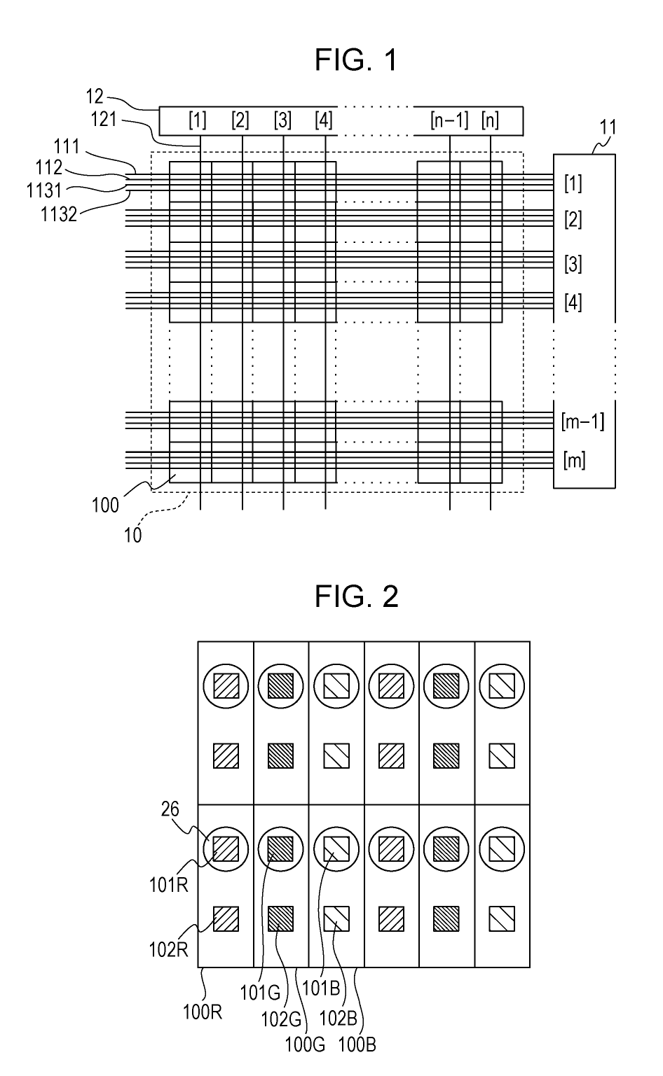

Embodiments of the present invention are specifically described below with reference to the drawings. FIG. 1 is a plan view that schematically illustrates a configuration of an organic electroluminescent display apparatus (organic EL display apparatus) according to an embodiment of the present invention. The organic EL display apparatus according to the present embodiment includes a display region 10 in which a plurality of pixels 100 are two-dimensionally arranged in a matrix of m rows and n columns, a row control circuit 11, and a column control circuit 12, both of which are positioned in the vicinity of the display region 10, as illustrated in FIG. 1. Here, m and n are natural numbers.

Each of the pixels 100 in the display region 10 includes a pixel circuit that includes organic electroluminescent elements (organic EL elements) and thin-film transistors (TFTs) for controlling currents to be supplied to the organic EL elements. An array of sub-pixels in each pixel 100 is described below. Each of the organic EL elements indicates a structure that includes two electrodes and an organic compound layer containing a light emission layer sandwiched between these two electrodes. Any transistor other than a TFT may be used as long as it controls a current to be supplied to the organic EL element. Any transistor other than a TFT may be used as a TFT described in the following description in the specification; the advantageous effects of the present invention are obtainable in both cases.

A plurality of gate control signals P1(1) to P1(m), P2(1) to P2(m), P31(1) to P31(m), and P32(1) to P32(m) are output from the output terminals of the row control circuit 11. The gate control signal P1, the gate control signal P2, the gate control signal P31, and the gate control signal P32 are input to a pixel circuit at each row through a gate line 111, a gate line 112, a gate line 1131, and a gate line 1132, respectively. An image signal is input to the column control circuit 12, and a data voltage Vdata being a gradation display signal is output from each output terminal. A reference voltage Vsl is also output therefrom. The data voltage data Vdata, which is a gradation display signal, and the reference voltage Vsl are input to a pixel circuit at each column through a corresponding data line 121. Connection of the data line 121 may be switched using, as different lines, a data line through which a data voltage is output and a reference-voltage line through which a reference voltage is output. A data voltage input as a gradation display signal has a voltage value between a minimum gradation display signal voltage that corresponds to the black display state and a maximum gradation display signal voltage that corresponds to the white display state and is used to perform gradation display.

A pixel arrangement and a pixel array of the organic EL display apparatus of the present embodiment are described with reference to FIG. 2. The organic EL display apparatus of the present embodiment includes pixels 100R, 100G, and 100B for three different hues of red (R), green (G), and blue (B). These pixels are two-dimensionally arranged in the display region, as illustrated in FIG. 2. Each of the pixels 100R, 100G, and 100B in the display region includes a plurality of sub-pixels having the same hue and different optical properties. For the present embodiment, the pixel 100R includes a first sub-pixel 101R and a second sub-pixel 102R; the pixel 100G includes a first sub-pixel 101G and a second sub-pixel 102G; and the pixel 100B includes a first sub-pixel 101B and a second sub-pixel 102B. Each of the first sub-pixels 101R, 101G, and 101B includes a pixel circuit that includes a first organic EL element and a TFT for controlling a current to be supplied to the first organic EL element. Each of the second sub-pixels 102R, 102G, and 102B includes a second organic EL element and a TFT for controlling a current to be supplied to the second organic EL element. For the present embodiment, each of the first sub-pixels 101R, 101G, and 101B is a sub-pixel with a front luminance increased by having a configuration described below, and each of the second sub-pixels 102R, 102G, and 102B is a sub-pixel with a front luminance lower than that of the first sub-pixel and with a large view angle.

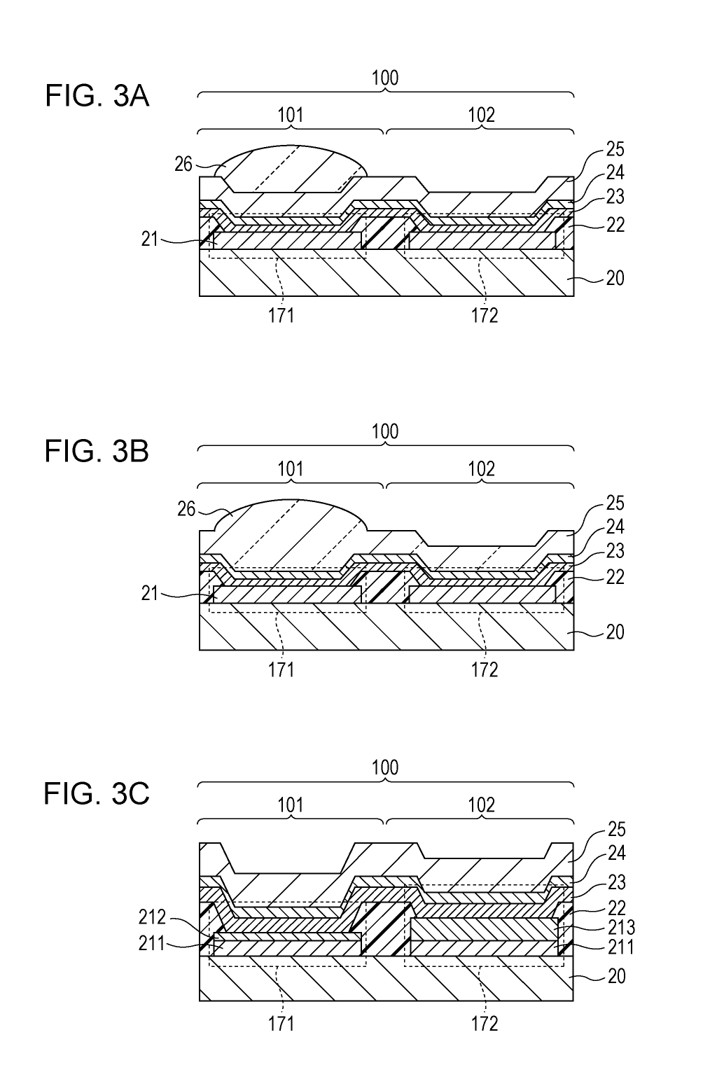

FIGS. 3A to 3C are cross-sectional views that schematically illustrate configurations of one pixel region of the organic EL display apparatus of the present embodiment and are common to R, G, and B. As illustrated in FIG. 3A, the organic EL display apparatus of the present embodiment includes a circuit element portion (not illustrated) formed on a substrate 20. The circuit element portion has a wiring structure (not illustrated) that includes a switching TFT (not illustrated), a driving TFT (not illustrated), a gate line containing a scan signal line, a data line, and a power line. A planarization layer (not illustrated) is disposed on the circuit element portion. The planarization layer has a contact hole (not illustrated) for allowing continuity between an electrode in the upper portion of the planarization layer and the circuit element portion.

A reflective electrode 21 is disposed on the planarization layer in the display region 10. The reflective electrode 21 is connected to the driving TFT through the contact hole. The reflective electrode 21 can be made of a light reflective member; examples of that material can include chromium, aluminum, silver, gold, and platinum. The use of such a light reflective member in the reflective electrode 21 improves the light extraction efficiency. A configuration that ensures the reflecting function by the use of the light reflective member described above and ensures the function as an electrode by the use of a transparent conductive film, such as an indium tin oxide (ITO) film, disposed on the light reflective member is also included in the reflective electrode 21. In this case, the reflective surface of the reflective electrode 21 is a surface of the light reflective member. A publicly known technique can be used as a film forming and patterning technique for the reflective electrode 21. The reflective electrode 21 is divided into sections corresponding to the first sub-pixel 101 and the second sub-pixel 102, the sections are connected to the circuit element portion, and a first organic EL element 171 and a second organic EL element 172 can be driven independently.

A partition 22 is disposed on the reflective electrode 21 so as to cover the edges of the reflective electrode 21. The partition 22 has an opening through which the substantially central section of the reflective electrode 21 is exposed. A publicly known material, such as acrylic resin or polyimide resin, can be used as the material of the partition. An organic compound layer (organic EL layer) 23 is disposed at and above the opening of the reflective electrode 21. The organic compound layer 23 can be formed by vapor deposition using a shadow mask. The organic compound layer 23 contains a light emission layer and may further contain a hole injection layer, a hole transport layer, an electron transport layer, an electron injection layer, and other layers if desired. A publicly known material can be used in the organic layer containing the light emission layer included in the organic compound layer 23.

A second electrode 24 is disposed on the organic compound layer 23. A transparent conductive film, such as an ITO or IZO (trademark) film, or a semitransparent film made of a metal material, such as silver or aluminum, having a thickness of approximately 10 nm to 30 nm can be used in the second electrode 24. The second electrode 24 can be formed by a publicly known technique, such as vapor deposition or sputtering. The second electrode 24 is connected to the circuit element portion through a contact section (not illustrated) outside the display region 10.

The reflective electrode 21, organic compound layer 23, and second electrode 24 form the organic EL element 171 in the sub-pixel 101 and the organic EL element 172 in the sub-pixel 102.

A protective layer 25 for protecting the organic EL elements 171 and 172 against water and oxygen is disposed on the second electrode 24. The protective layer 25 contains an inorganic layer made of an inorganic material. The protective layer 25 may be an inorganic single-layer configuration, or alternatively, a configuration in which an inorganic layer and an organic layer made of, for example, organic resin are laminated. A publicly known inorganic material, such as SiN, can be used in the inorganic layer contained in the protective layer 25. The inorganic layer can have a thickness between approximately 0.1 μm and 10 μm and be formed by a technique such as sputtering or chemical-vapor deposition (CVD). With this, the organic EL elements can be satisfactorily covered, and the protection can be enhanced. In the case of a configuration in which inorganic and organic layers are laminated, the organic layer can have a thickness at or above 1 μm to increase protective performance by covering an unremovable foreign substance attached to the surface in a process. The protective layer 25 illustrated in FIG. 3A, which is disposed along the shape of the partition 22, may have a substantially flat surface. The surface can be substantially flat by the use of an organic material.

For the present embodiment, a condensing lens 26 is disposed directly above the first organic EL element 171 in the first sub-pixel 101. A section directly above the second organic EL element 172 has a substantially flat surface. With this configuration, concentrating light output from the first organic EL element 171 by the condensing lens 26 makes the front luminance of the first sub-pixel 101 larger than that of the second sub-pixel 102.

The condensing lens 26 is formed by processing a resin material. Specifically, the condensing lens 26 can be formed by, for example, stamping. Examples of other methods that can be used in producing the lens include the following i) to v):

i) a method of treating a resin layer patterned by, for example, photolithography with heat and altering the shape of the resin layer into a lens shape by reflowing
ii) a method of exposing a photo-curable resin layer having a substantially uniform thickness with light distributed in an in-plane direction and forming a lens by developing this resin layer
iii) a method of processing the surface of a resin material having a substantially uniform thickness into a lens shape using, for example, an ion beam, an electron beam, a laser, or other beams
iv) a method of dripping a proper amount of resin on each pixel and forming a lens in a self-aligning manner
v) a method of preparing a resin sheet on which a lens has been previously formed, separately from a substrate on which an organic EL element has been formed, aligning both the resin sheet and the substrate, and then bonding them together to form a lens

If the protective layer 25 includes multiple layers and part of the multiple layers is made of organic resin, the resin may be processed into a lens shape. An example cross-sectional configuration in this case is illustrated in FIG. 3B. The use of the resin enables a substantially flat surface and also enables substantially flattening a region where no lens is disposed, as illustrated in FIG. 3B.

With such a configuration, for the first organic EL element 171, at which the condensing lens 26 is disposed, light output from the organic compound layer 23 passes through the second electrode 24, then the protective layer 25, then the condensing lens 26, and is output to the outside of the organic EL display apparatus. For the configuration including the condensing lens 26, in comparison with the configuration without the lens, the output angle is nearer in a direction substantially perpendicular to the substrate. Accordingly, the effect of concentrating light in the direction substantially perpendicular to the substrate for the case with the lens is higher than that for the case without the lens. That is, the efficiency of utilization of light in the frontal direction as the display apparatus can be improved. For the configuration with the condensing lens 26, because an incidence angle of light obliquely output from the light emission layer with respect to the output interface is close to the perpendicularity, the quantity of light of total reflection decreases. As a result, the light extraction efficiency also increases.

In contrast, for the second organic EL element 172, at which no lens is disposed, light obliquely output from the light emission layer of the organic compound layer 23 is further obliquely output from the protective layer 25.

For the present embodiment, the sub-pixels 101 and 102 have different optical properties in the above-described manner. The first sub-pixel 101 is a sub-pixel whose front luminance is increased by the effect of concentrating light of the lens, whereas the second sub-pixel 102 is a sub-pixel in which light is not concentrated by a lens and whose view angle is large.

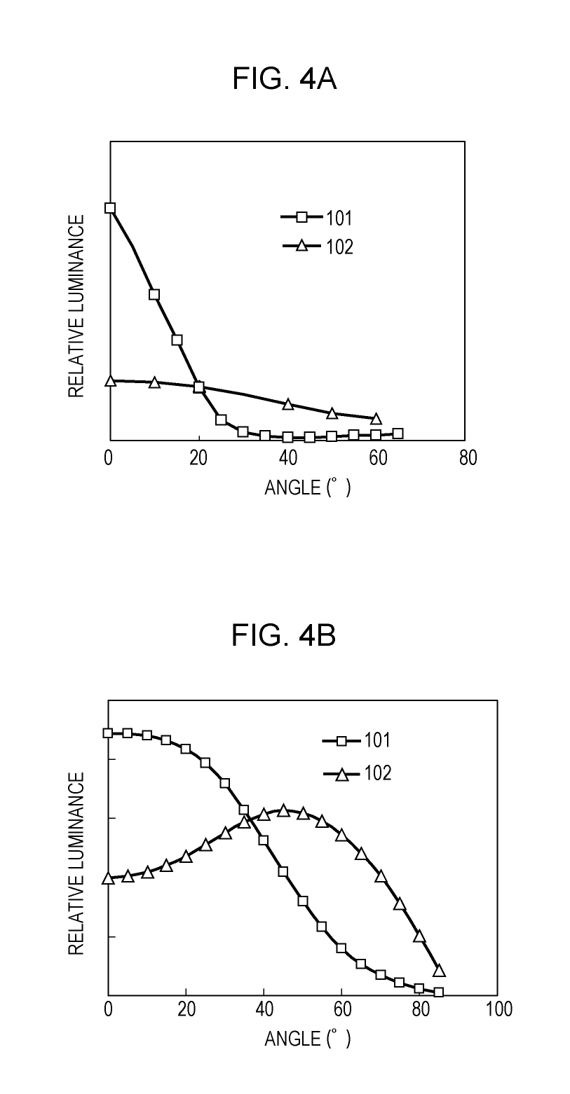

FIG. 4A illustrates a dependence of a luminance on an angle of each of the first sub-pixel 101 and the second sub-pixel 102 for an R pixel. In FIG. 4A, the front luminance of the second sub-pixel 102 is one, and the luminance at an angle tilted from the front is expressed as a relative luminance value. As illustrated in FIG. 4A, the first sub-pixel 101 has an optical property of a high front luminance, whereas the second sub-pixel 102 has an optical property of a large view angle. Each of a G pixel and a B pixel has substantially the same property as in an R pixel as long as they have the same configuration.

A concrete configuration in which a plurality of sub-pixels included in a pixel have different optical properties in the present invention is not limited to the above-described one in which a lens is disposed in one of the sub-pixels such that the lens is adjacent to a light emitting surface of the organic EL element. For example, making the organic EL elements 171 and 172 have different optical interference conditions can increase the front luminance of one of the sub-pixels included in a pixel.

FIG. 3C illustrates a cross-sectional configuration when the organic EL elements 171 and 172 have different optical interference conditions. The cross-sectional configuration illustrated in FIG. 3C differs from that in FIG. 3A only in the configuration of a reflective electrode in each of the organic EL elements 171 and 172. For the configuration illustrated in FIG. 3C, the reflective electrode includes a reflective metal layer 211 and electrode layers 212 and 213. The reflective metal layer 211 and the electrode layer 212 are disposed in the first sub-pixel 101, whereas the reflective metal layer 211 and the electrode layer 213 are disposed in the second sub-pixel 102. The reflective metal layer 211 is divided into sections corresponding to the sub-pixels 101 and 102, the sections are connected to the circuit element portion, and the organic EL elements 171 and 172 can be driven independently.

The reflective metal layer 211 is made of a conductive metal material that has a high reflectance, such as silver or aluminum. Each of the electrode layers 212 and 213 is made of a transparent conductive material that has satisfactory hole injection characteristics, such as ITO or IZO. The electrode layers 212 and 213 have different thicknesses. Layers above the electrode layer 212 and those above the electrode layer 213 have substantially the same thicknesses. In this manner, the organic EL elements 171 and 172 having different interference conditions can be formed. Table 1 below provides an example thickness of each of the layers of the organic EL element 171 and organic EL element 172 for an R pixel. The dependence of a luminance to an angle in this example is shown in FIG. 4B.

TABLE 1

| | Pixel | |
|---|---|---|
| | Organic EL | Organic EL |
| | Element 171 | Element 172 |
| Second Electrode | 50 nm | |
| Layer (ITO) | | |
| Second Electrode | 12 nm | |
| Layer (Ag) | | |
| Electrode Injection | 28 nm | |
| Layer | | |
| Electrode Transport | 20 nm | |
| Layer | | |
| Light Emission Layer | 30 nm | |
| Hole Transport Layer | 253 nm | |
| Electrode Layer | 10 nm | 125 nm |
| (IZO) | | |

| | |
|---|---|
| Reflective Metal | 500 nm |
| Layer (Ag) | |

In FIG. 4B, the front luminance of the first sub-pixel 101 (organic EL element 171) is one, and the luminance at an angle tilted from the front is expressed as a relative luminance value. As illustrated in FIG. 4B, the first sub-pixel 101 has an optical property of a high front luminance, whereas the second sub-pixel 102 (organic EL element 172) has an optical property of a large view angle. At this time, the front chromaticity (CIEx, CIEy) of the first sub-pixel 101 is (0.67, 0.33), and the front chromaticity (CIEx, CIEy) of the second sub-pixel 102 is (0.69, 0.31). Each of a G pixel and a B pixel has substantially the same property as in an R pixel described here as long as they have the same configuration.

A method of driving an organic EL display apparatus according to an embodiment of the present invention is described below.

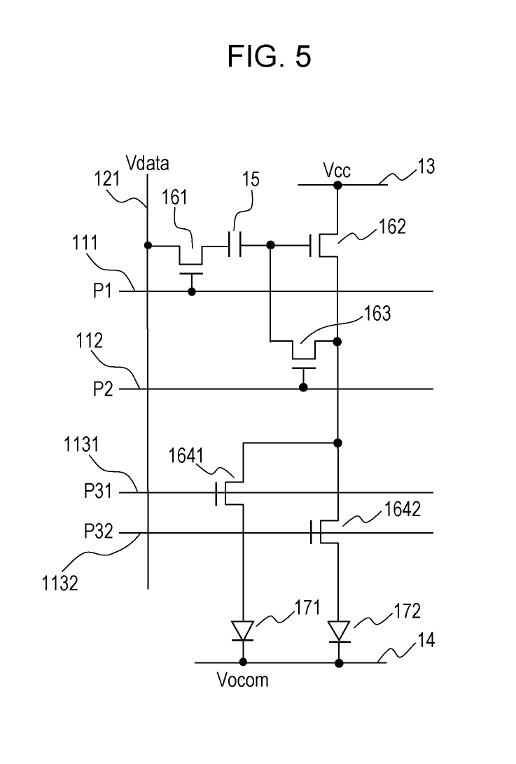

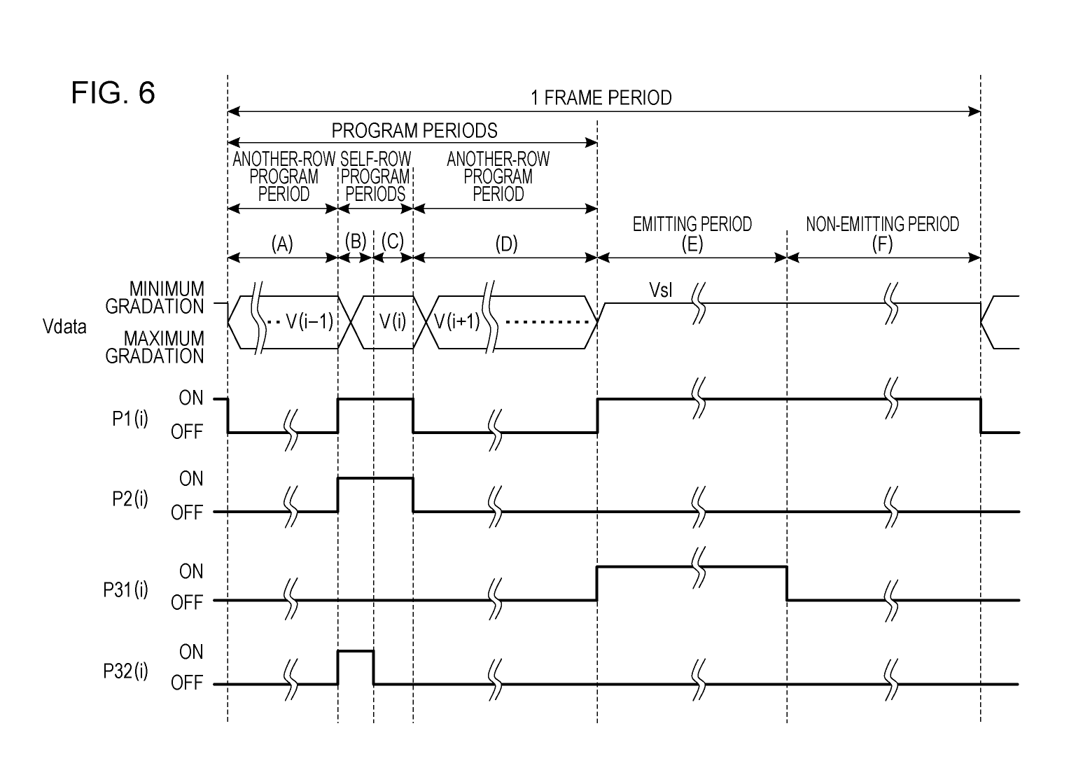

FIG. 5 illustrates an example configuration of a pixel circuit of each pixel of the organic EL display apparatus according to the embodiment of the present invention. FIGS. 6 to 8 are timing charts that illustrate example drive sequences for the pixel circuit illustrated in FIG. 5.

As illustrated in FIG. 5, the organic EL display apparatus according to the embodiment of the present invention includes pixels each including a selecting TFT 161 being a switching TFT, an erasing TFT 163, a first emitting-period control TFT 1641, a second emitting-period control TFT 1642, a driving TFT 162, a storage capacitor 15, the first organic EL element 171, and the second organic EL element 172. Each of the selecting TFT 161, the first emitting-period control TFT 1641, the second emitting-period control TFT 1642, and the erasing TFT 163 is an N-type TFT, whereas the driving TFT 162 is a P-type TFT.

As illustrated in FIG. 5, for the organic EL display apparatus according to the embodiment of the present invention, the selecting TFT 161, the erasing TFT 163, the driving TFT 162, the storage capacitor 15, a power line 13, the data line 121, and the gate lines 111 and 112 are shared by the first sub-pixel 101 and the second sub-pixel 102. The drain terminal of the driving TFT 162 is connected to one terminal of the erasing TFT 163, and the connection blanches to the first emitting-period control TFT 1641 and the second emitting-period control TFT 1642.

A connection form is described in detail below.

Of the selecting TFT 161, the gate terminal is connected to the gate line 111, a first terminal is connected to the data line 121, and a second terminal is connected to the storage capacitor 15.

Of the erasing TFT 163, the gate terminal is connected to the gate line 112, a first terminal is connected to the gate terminal of the driving TFT 162, and a second terminal is connected to the drain terminal of the driving TFT 162 and the drain terminal of each of the first emitting-period control TFT 1641 and the second emitting-period control TFT 1642.

Of the driving TFT 162, the source terminal is connected to the power line 13, and the drain terminal is connected to the second terminal of the erasing TFT 163 and the drain terminal of each of the first emitting-period control TFT 1641 and the second emitting-period control TFT 1642.

Of the first emitting-period control TFT 1641, the gate terminal is connected to the gate line 1131 and the source terminal is connected to the anode of the first organic EL element 171; Of the second emitting-period control TFT 1642, the gate terminal is connected to the gate line 1132 and the source terminal is connected to the anode of the second organic EL element 172. The cathode of each of the first organic EL element 171 and the second organic EL element 172 is connected to a ground line 14. The storage capacitor 15 is arranged between the selecting TFT 161 and each of the gate terminal of the driving TFT 162 and the first terminal of the erasing TFT 163.

For the organic EL display apparatus according to the present embodiment, the first organic EL element 171 corresponds to the first sub-pixel 101, the second organic EL element 172 corresponds to the second sub-pixel 102, and the light emissions of the first and second organic EL elements are controlled by the first emitting-period control TFT 1641 and the second emitting-period control TFT 1642, respectively. For the present configuration, the gate terminal of the first emitting-period control TFT 1641 and that of the second emitting-period control TFT 1642 are connected to the independent gate lines 1131 and 1132, respectively. Therefore, the light emissions of the first sub-pixel 101 and the second sub-pixel 102 can be independently controlled by the use of gate control signals P31 and P32. Accordingly, the light emissions of the sub-pixels 101 and 102 can be turned on or off at the same time, and they can also be driven so as to be independently turned on or off. Because the first organic EL element 171 and second organic EL element 172 receive a current from the same driving TFT 162, their light emissions are controlled by the same gradation display signal.

If the sub-pixels 101 and 102 are driven independently, displaying with a large view angle can be achieved when only the light emission of the second sub-pixel 102 is turned on. When only the light emission of the first sub-pixel 101 is turned on, displaying with a small view angle but with a high front luminance can be achieved. Driving the first sub-pixel 101 having an increased front luminance with a low current enables obtaining substantially the same luminance as in a pixel whose front luminance is not increased using a low current. This leads to low power consumption.

Accordingly, for the organic EL display apparatus according to the present embodiment, a user can select “displaying with enhanced efficiency of utilization of light and an increased front luminance,” “displaying with a large view angle,” or “displaying with low power consumption” in response to the necessity.

If the sub-pixels 101 and 102 are driven at the same time, the efficiency of utilization of light can be enhanced by the first sub-pixel 101 with an increased front luminance while a reduction in the luminance to an oblique direction can be suppressed by the second sub-pixel 102 with a large view angle and the view-angle characteristics can be improved. That is, displaying in which the efficiency of utilization of light is enhanced while satisfactory view-angle characteristics are maintained can be achieved.

FIGS. 6 to 8 are timing charts of drive sequences of a pixel circuit in an i-th row of the organic EL display apparatus according to the present embodiment. The drive sequences of the present embodiment have, in one frame, program periods (A) to (D) where a gradation display signal is written in each pixel. The remaining periods are separated into an emitting period (E) where an organic EL element of a target pixel emits light and a non-emitting period (F) where the organic EL element of the target pixel is controlled so as not to emit light. Any ratio between the periods (E) and (F) can be used.

The program periods (A) to (D) consist of the self-row program periods (B) and (C), where a gradation display signal is written in a target pixel at a target row in a target column, and the another-row program periods (A) and (D), where a gradation display signal is written in a pixel at a row other than the target row. The self-row program periods include the discharge period (B) and the written period (C). V(i−1), V(i), and V(i+1) indicate data voltages Vdata input to pixel circuits at an (i−1)-th row (immediately before a target row), an i-th row (target row), and an (i+1)-th row (immediately after the target row) in a target column in one frame period.

Operations in the periods in a drive sequence are described in the following cases [1] to [3]: [1] the case where a first sub-pixel having a high front luminance is driven, [2] the case where a second sub-pixel having a large view angle is driven, and [3] the case where both a first sub-pixel having a high front luminance and a second sub-pixel having a large view angle are driven at the same time.

[1] Case where a First Sub-Pixel Having a High Front Luminance is Driven

FIG. 6 is a timing chart of a drive sequence when the first sub-pixel having a high front luminance is driven in the organic EL display apparatus according to the present embodiment. In this mode, the second sub-pixel 102 is energized in the discharge period (B) of the program periods. In the emitting period (E), the first sub-pixel 101 is energized, and the first organic EL element 171 having an increased front luminance emits light.

### (A) Another-Row Program Period (Before Target Row)

In this period, for a pixel circuit in a target row, a low-level (L-level) signal is input as P1(i) to the gate line 111, and the selecting TFT 161 is in an OFF state. An L-level signal is input as P2(i) to the gate line 112, and the erasing TFT 163 is in an OFF state. In this state, a data voltage Vdata being a gradation display signal for a previous row is not input to the pixel circuit in the i-th row being the target row. L-level signals are input as P31(i) and P32(i) to the gate lines 1131 and 1132, respectively, and both the emitting-period control TFTs 1641 and 1642 are in an OFF state.

### (B) Discharge Period

In this period, a high-level (H-level) signal is input to each of the gate lines 111, 112, and 1132, and the selecting TFT 161, the erasing TFT 163, and the second emitting-period control TFT 1642 are in an ON state. An L-level signal is input to the gate line 1131, and the first emitting-period control TFT 1641 is in an OFF state. A data voltage V(i) being the gradation display signal for the target row is set in the data line 121, and the data voltage V(i) (display information) is input to the data line side of the storage capacitor 15.

Because the erasing TFT 163 is turned to an ON state, the gate terminal of the driving TFT 162 and the ground line 14 are connected through the emitting-period control TFT 1642 and the organic EL element 172. The gate voltage of the driving TFT 162 is close to the ground line potential Vocom, irrespective of the voltage in the immediately preceding state, and the driving TFT 162 is turned to an ON state. At this time, because the organic EL element 172 is energized, light emission occurs in the second sub-pixel 102. In response to this, the display information (data voltage) for the previous frame stored in the storage capacitor 15 is erased through the organic EL element 172. In contrast, the organic EL element 171 is not energized because the first emitting-period control TFT 1641 is in an OFF state, and no light emission occurs in the first sub-pixel 101.

### (C) Written Period

In this period, an L-level signal is input to each of the gate lines 1131 and 1132, and the emitting-period controls TFTs 1641 and 1642 are in an OFF state. Thus, a current flows from the drain terminal to the gate terminal of the driving TFT 162, and the gate-source voltage of the driving TFT 162 approaches the threshold voltage of the driving TFT 162. The gate voltage of the driving TFT 162 at this time is input to a side of the storage capacitor 15 that is connected to the gate terminal of the driving TFT 162. The data voltage V(i) being the gradation display signal in the target row has been set in the data line 121 continuously since the period (B), and the data voltage V(i) is input to the data line side of the storage capacitor 15. The storage capacitor 15 is charged with an electric charge corresponding to the voltage of the difference between the gate voltage of the driving TFT 162 and the data voltage V(i), and the gradation display signal is programmed.

(D) Another-Row Program Period (after Target Row)

In this period, an L-level signal is input to each of the gate lines 111, 112, 1131, and 1132, and the selecting TFT 161, the erasing TFT 163, and the emitting-period control TFTs 1641 and 1642 are in an OFF state. Even when the data-line voltage is changed to the data voltage Vdata being the gradation display signal for a subsequent row, the electric charge charged in the storage capacitor 15 in the period (C) is retained.

### (E) Emitting Period

In this period, an H-level signal is input to the gate line 111, and the selecting TFT 161 is in an ON state. A reference voltage Vsl is set in the data line 121. Thus, the reference voltage Vsl is input to the data-line side of the storage capacitor 15. Because the erasing TFT 163 is in an OFF state in this period, the electric charge charged in the storage capacitor 15 in the period (C) is retained. Therefore, the gate voltage of the driving TFT 162 is changed by the difference between the data voltage V(i) and the reference voltage Vsl.

After that, in the periods (E) and (F), an H-level signal is input to the gate line 111 and an L-level signal is input to the gate line 112. Thus, the ON state of the selecting TFT 161 and the OFF state of the erasing TFT 163 remain in the periods (E) and (F), and the gate voltage of the driving TFT 162 remains at a constant voltage in the period (E). In this period, an H-level signal is input to the gate line 1131, and the first emitting-period control TFT 1641 is turned to an ON state. Therefore, a current corresponding to the gate voltage of the driving TFT 162 is supplied to the organic EL element 171, and the organic EL element 171(first sub-pixel 101) emits light with a luminance of gradation corresponding to the supplied current. In this period, an L-level signal is input to the gate line 1132, and the emitting-period control TFT 1642 is in an OFF state. Thus, the organic EL element 172 is not energized, and no light emission occurs in the second sub-pixel 102.

For the present embodiment, the organic EL element 171 in the first sub-pixel 101 is an organic EL element with an increased front luminance. Accordingly, displaying with a high front luminance can be achieved in this emitting period (E).

### (F) Non-Emitting Period

In this period, an L-level signal is input to each of the data lines 1131 and 1132, and the emitting-period control TFTs 1641 and 1642 are in an OFF state. Thus, in this period, the organic EL elements 171 and 172 do not emit light.

When the organic EL display apparatus according to the present embodiment is driven in this mode, because the first sub-pixel 101 including the organic EL element 171 with an increased front luminance emits light in the emitting period (E), displaying with a high front luminance can be achieved. The gradation display signal in a previous frame is reset, and in the discharge period (B) of the periods (B) and (C), where a gradation display signal for the target frame is programmed, the second sub-pixel 102 is energized and the first sub-pixel 101 is not energized. Accordingly, superimposed light that is emitted in this period and then superimposed on emitted light for achieving gradation display in the emitting period (E) results solely from the second sub-pixel 102 with a low front luminance. This enables an increased contrast in mode with a high front luminance.

Here, the contrast indicates the ratio between emitted light for achieving gradation display in the emitting period (E) and the total amount of emitted light in the program periods (A) to (D) and the non-emitting period (F). For the organic EL display apparatus according to the present embodiment, in the discharge period (B), the second sub-pixel 102, whose front luminance is not maximum, is energized. This can reduce the emitted light (superimposed light) in the period (B) and reduce the total amount of emitted light in the program periods (A) to (D) and the non-emitting period (F), thereby increasing the contrast.

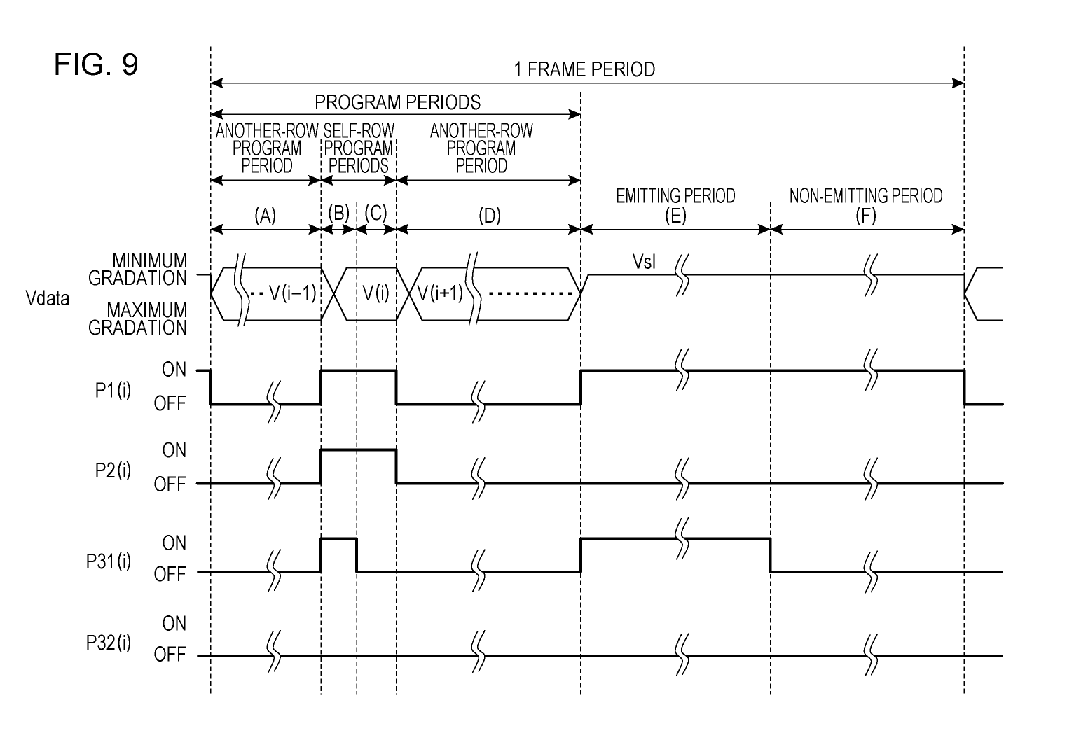

FIG. 9 illustrates a timing chart of a drive sequence according to a comparative example for the present embodiment. Only the differences from the drive sequence illustrated in FIG. 6 are described below.

The drive sequence illustrated in FIG. 9 differs from that illustrated in FIG. 6 only in the operation in the discharge period (B); the operations in the other periods are substantially the same. That is, in the discharge period (B), an H-level signal is input to the gate line 1131, and the emitting-period control TFT 1641 is in an ON state. An L-level signal is input to the gate line 1132, and the emitting-period control TFT 1642 is in an OFF state. The erasing TFT 163 is turned to an ON state, and the gate terminal of the driving TFT 162 and the ground line 14 are connected together through the emitting-period control TFT 1641 and the organic EL element 171. The gate voltage of the driving TFT 162 is close to the ground line potential Vocom, irrespective of the voltage in the immediately preceding state, and the driving TFT 162 is turned to an ON state. At this time, because the organic EL element 171 is energized, light emission occurs in the first sub-pixel 101. The organic EL element 172 is not energized because the emitting-period control TFT 1642 is in an OFF state, and no light emission occurs in the second sub-pixel 102.

For the drive sequence illustrated in FIG. 9, because the first sub-pixel 101 including the organic EL element 171 with an increased front luminance emits light in the emitting period (E), displaying with a high front luminance can be achieved. However, because the first sub-pixel 101 is energized in the discharge period (B), superimposed light that is emitted in this period and then superimposed on emitted light for achieving gradation display in the emitting period (E) results from light emitted from the first sub-pixel 101 with an increased front luminance. Therefore, the contrast in mode with a high front luminance is lower than that in the mode illustrated in FIG. 6.

[2] Case where a Second Sub-Pixel Having a Large View Angle is Driven

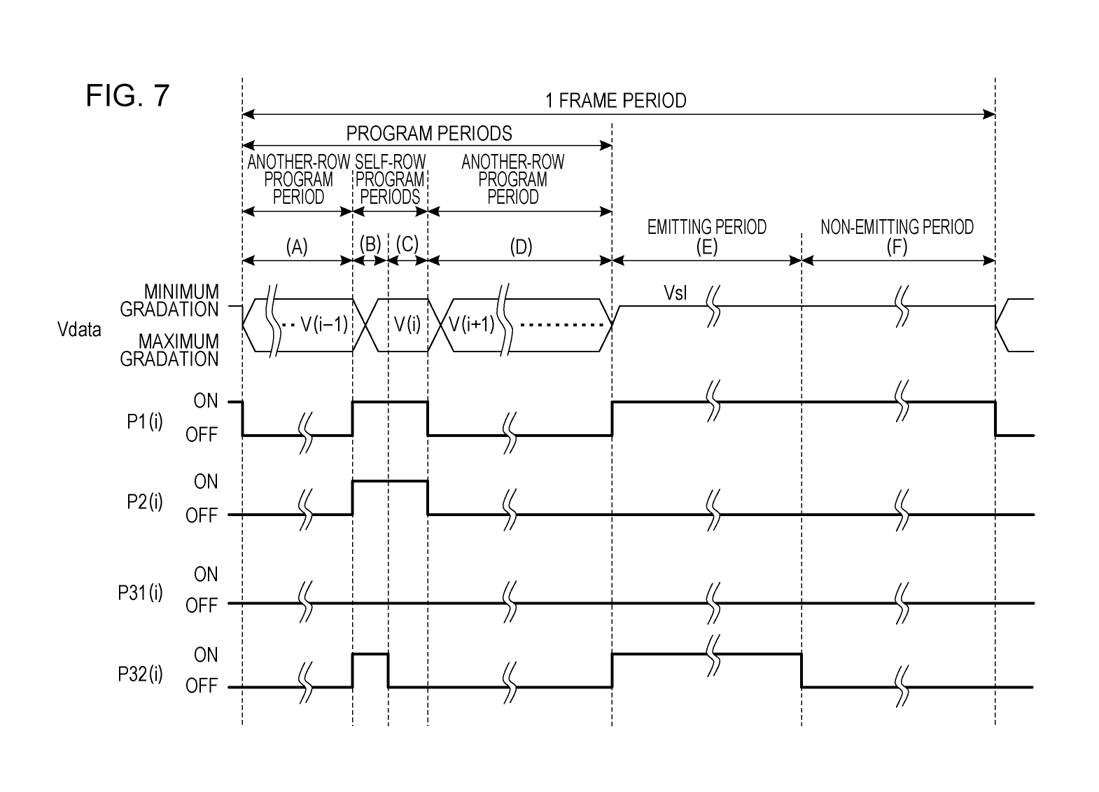

FIG. 7 is a timing chart of a drive sequence when the second sub-pixel 102 having a large view angle is driven in the organic EL display apparatus according to the present embodiment. The case [2] driven in this mode differs from the above-described case [1] driven in the mode with a high front luminance illustrated in FIG. 6 only in the operation in the emitting period (E); the operations in the other periods are substantially the same. Only the differences are described below.

In this mode, in the emitting period (E), an H-level signal is input to the gate line 1132, and the emitting-period control TFT 1642 is turned to an ON state. Thus, a current corresponding to the gate voltage of the driving TFT 162 is supplied to the organic EL element 172, and the organic EL element 172(second sub-pixel 102) emits light with a luminance of gradation corresponding to the supplied current. In this period, an L-level signal is input to the gate line 1131, and the emitting-period control TFT 1641 is in an OFF state. Thus, the organic EL element 171 is not energized, and no light emission occurs in the first sub-pixel 101.

For the organic EL display apparatus according to the present embodiment, the organic EL element 172 in the second sub-pixel 102 is an organic EL element with a front luminance that is not increased and with a large view angle. Accordingly, displaying with a large view angle in this emitting period (E) can be achieved.

[3] Case where Both a First Sub-Pixel Having a High Front Luminance and a Second Sub-Pixel Having a Large View Angle are Driven at the Same Time

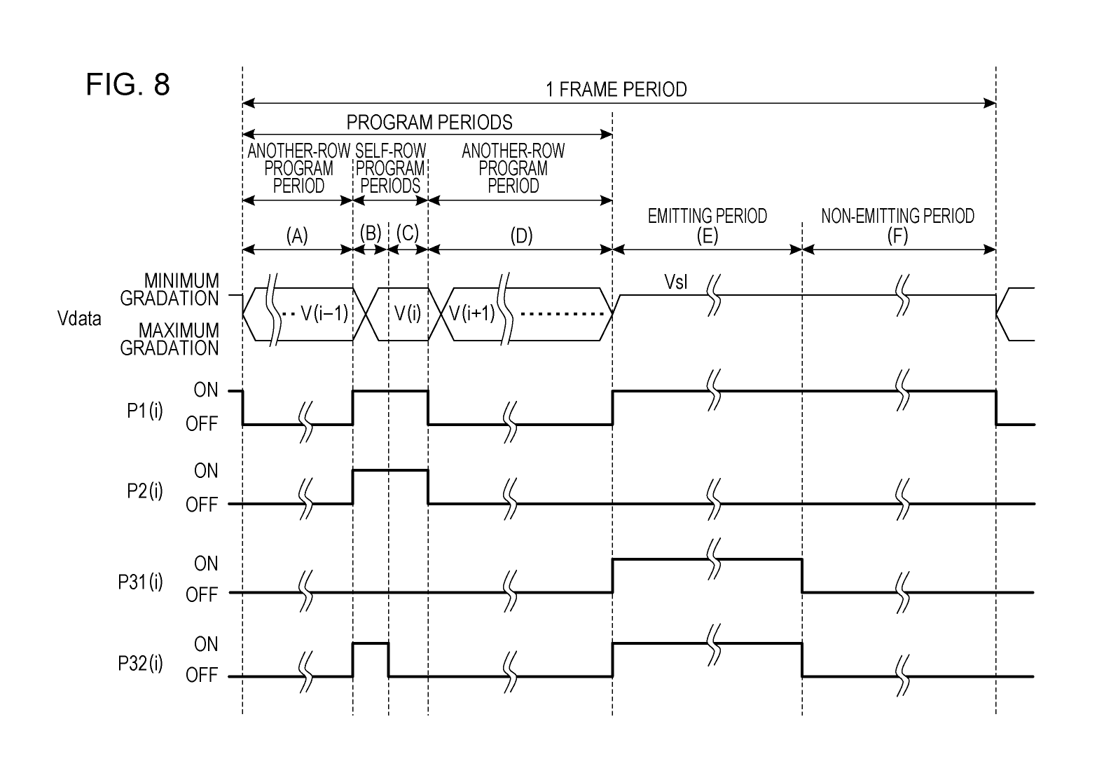

FIG. 8 is a timing chart of a drive sequence when both the first sub-pixel 101 with a high front luminance and the second sub-pixel 102 with a large view angle are driven at the same time. The case [3] driven in this mode differs from the foregoing case [1] driven in the mode with a high front luminance illustrated in FIG. 6 and the foregoing case [2] driven in the mode with a large view angle illustrated in FIG. 7 only in the operation in the emitting period (E); the operations in the other periods are substantially the same. Only the differences are described below.

In this mode, in the emitting period (E), an H-level signal is input to each of the gate lines 1131 and 1132, and the emitting-period control TFTs 1641 and 1642 are turned to an ON state. Thus, a current corresponding to the gate voltage of the driving TFT 162 is supplied to the organic EL elements 171 and 172, and the organic EL element 171 (first sub-pixel 101) and the organic EL element 172 (second sub-pixel 102) emit light with a luminance of gradation corresponding to the supplied current.

For the organic EL display apparatus according to the present embodiment, in this mode, the first sub-pixel 101 including the organic EL element 171 with an increased front luminance and the second sub-pixel 102 including the organic EL element 172 with a large view angle emit light in the emitting period (E). Thus, displaying in which the efficiency of utilization of light is enhanced while a small view angle is compensated for by light emitted from the second sub-pixel 102 can be achieved, in contrast to the foregoing mode [1] with a high front luminance but with a small view angle.

The gradation display signal in a previous frame is reset, and in the discharge period (B) of the periods (B) and (C), where a gradation display signal for the target frame is programmed, the second sub-pixel 102 is energized and the first sub-pixel 101 is not energized. Accordingly, superimposed light that is emitted in this period and then superimposed on emitted light for achieving gradation display in the emitting period (E) results solely from the second sub-pixel 102, which has a front luminance lower than that of the first sub-pixel 101. This enables an increased contrast.

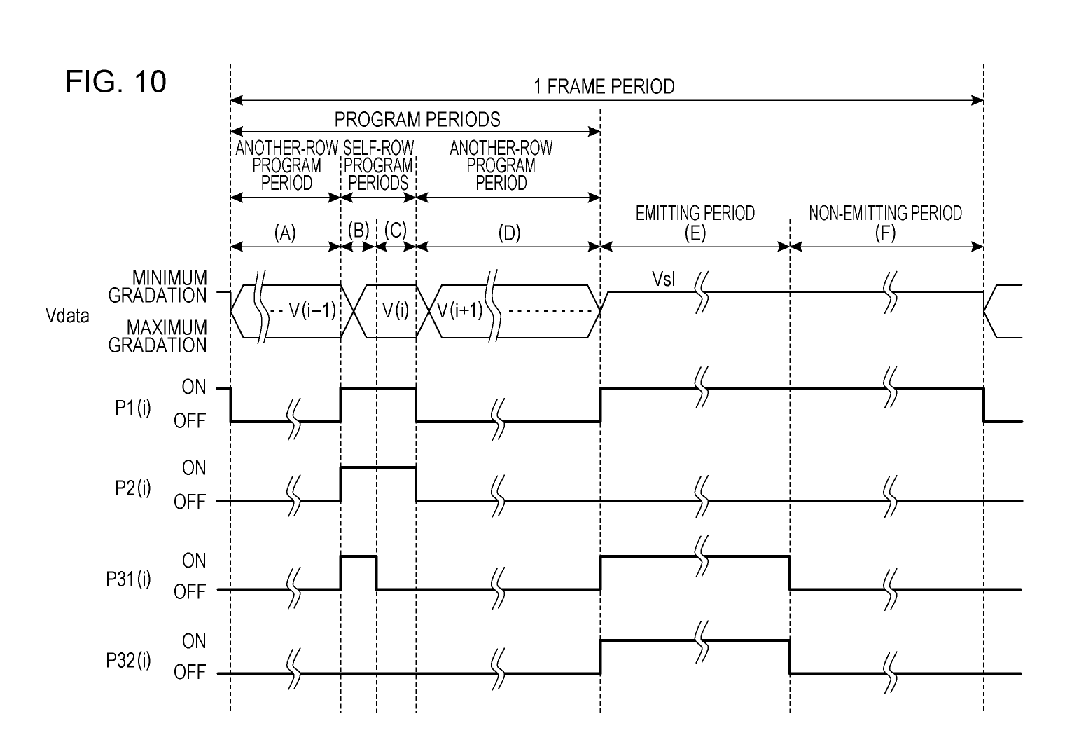

FIG. 10 is a timing chart of a drive sequence according to a comparative example for the present embodiment. Only the differences from the drive sequence illustrated in FIG. 8 are described below.

The drive sequence illustrated in FIG. 10 differs from that illustrated in FIG. 8 only in the operation in the discharge period (B); the operations in the other periods are substantially the same. That is, in the discharge period (B), an H-level signal is input to the gate line 1131, and the emitting-period control TFT 1641 is in an ON state. An L-level signal is input to the gate line 1132, and the emitting-period control TFT 1642 is in an OFF state. The erasing TFT 163 is turned to an ON state, and the gate terminal of the driving TFT 162 and the ground line 14 are connected together through the emitting-period control TFT 1641 and the organic EL element 171. The gate voltage of the driving TFT 162 is close to the ground line potential Vocom, irrespective of the voltage in the immediately preceding state, and the driving TFT 162 is turned to an ON state. At this time, because the organic EL element 171 is energized, light emission occurs in the first sub-pixel 101. The organic EL element 172 is not energized because the emitting-period control TFT 1642 is in an OFF state, and no light emission occurs in the second sub-pixel 102.

For the drive sequence illustrated in FIG. 10, the first sub-pixel 101 including the organic EL element 171 with an increased front luminance and the second sub-pixel 102 including the organic EL element 172 with a large view angle emit light in the emitting period (E). Therefore, displaying in which the efficiency of utilization of light is high and a small view angle is compensated for by light emitted from the second sub-pixel 102 can be achieved. However, because the first sub-pixel 101 is energized in the discharge period (B), superimposed light that is emitted in this period and then superimposed on emitted light for achieving gradation display in the emitting period (E) results from light emitted from the first sub-pixel 101 with an increased front luminance. Therefore, the contrast in this mode is lower than that in the mode illustrated in FIG. 8.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-204023 filed Sep. 13, 2010, which is hereby incorporated by reference herein in its entirety.

What is claimed is:

1. A method of driving a pixel of a display apparatus including a plurality of pixels,
wherein each of the plurality of pixels includes: a plurality of sub-pixels of the same hue each composed of a respective organic electroluminescent element, an emitting-period control transistor that controls an emitting period of each of the organic electroluminescent elements, a driving transistor that supplies a current to the organic electroluminescent element through the emitting-period control transistor, a storage capacitor that is connected to a gate terminal of the driving transistor and that stores display information, and an erasing transistor that is connected between the storage capacitor and a route from the driving transistor to the emitting-period control transistor, and
wherein the plurality of sub-pixels comprises a first sub-pixel and a second sub-pixel having a front luminance lower than that of the first sub-pixel,
the method comprising:
erasing display information stored in the storage capacitor as a gradation display signal in a previous frame in the pixel through the organic electroluminescent element of the second sub-pixel of the plurality of sub-pixels included in the pixel.

2. The method of driving a pixel of a display apparatus according to claim 1, wherein the first sub-pixel includes a condensing lens.

3. A display apparatus comprising:
a plurality of pixels,
wherein each of the plurality of pixels includes: a plurality of sub-pixels of the same hue each composed of a respective organic electroluminescent element, an emitting-period control transistor that controls an emitting period of each of the organic electroluminescent elements, a driving transistor that supplies a current to the organic electroluminescent element through the emitting-period control transistor, a storage capacitor that is connected to a gate terminal of the driving transistor and that stores display information, and an erasing transistor that is connected between the storage capacitor and a route from the driving transistor to the emitting-period control transistor,
wherein the plurality of sub-pixels comprises a first sub-pixel and a second sub-pixel having a front luminance lower than that of the first sub-pixel, and
wherein display information stored in the storage capacitor as a gradation display signal in a previous frame in the pixel is erased through the organic electroluminescent element of the second sub-pixel of the plurality of sub-pixels included in the pixel.

4. The display apparatus according to claim 3, wherein the first sub-pixel includes a condensing lens.
